(19) United States
(12) Patent Application Publication
(10) Pub. No.: US 2013/0078035 A1
(43) Pub. Date: Mar. 28, 2013

(54) FRONT RAIL FOR MERCHANDISING SYSTEM

(71) Applicant: Fasteners for Retail, Inc., Twinsburg, OH (US)

(72) Inventors: Paul Mueller, Wadsworth, OH (US); Gerald Szpak, Brecksville, OH (US); Gregory M. Bird, Solon, OH (US)

(73) Assignee: FASTENERS FOR RETAIL, INC., Twinsburg, OH (US)

(21) Appl. No.: 13/625,305

(22) Filed: Sep. 24, 2012

Related U.S. Application Data
(60) Provisional application No. 61/538,305, filed on Sep. 23, 2011.

(51) Int. Cl. F16B 12/00

(52) U.S. Cl. 403/345

(57) ABSTRACT

A merchandising system includes a front rail which is adapted to be selectively mounted to an associated shelf. The front rail includes a fastener element which is of one piece with the front rail. The fastener element selectively secures the front rail to the associated shelf.

### BACKGROUND

The present disclosure pertains generally to adjustable merchandising systems for shelving. More specifically, the present disclosure pertains to an easy to install front fence for an adjustable merchandiser used on shelving. The merchandiser can be removably attached to an associated shelf and is configured to organize merchandise on the shelf.

Shelving is used extensively for stocking and storing products or merchandise in a variety of stores. For a number of important merchandising considerations, it is desirable that merchandise be displayed at the front of a shelf so that a customer is induced to purchase the article. For example if the goods are perishable or are subject to becoming stale (e.g., cigarettes, fruit juices, dairy products or any item with an expiration date or a freshness date), it is important that the articles be removed in a first in, first out basis in order to maintain freshness. Also, if merchandise is not displayed at the front of the shelf, it may not catch the shopper's eye which may cost the merchant sales.

In order to automatically move an item forward on a shelf as the one before it is removed, several types of forward feed devices have been devised. These devices generally fall into three categories. The first category is inclined tracks. These rely on gravity to feed, slide or roll products forward. The second category employs conveyor belts which still use gravity to effect a forward movement. The third category uses spring biased paddles to feed the product forward. Whichever forward feed mechanism is employed, it is necessary that the front of the shelf be provided with a barrier or fence, so that the merchandise urged forward does not fall off the shelf.

The current front fences or front rails are disadvantageous from the standpoint that separate fasteners are required in order to secure the front rail or fence to the shelf. Accordingly, it has been considered desirable to develop a new and improved front rail which would overcome the foregoing difficulties and others, while providing better and more advantageous overall results.

### BRIEF SUMMARY OF THE DISCLOSURE

In accordance with the present disclosure, a new and improved front rail is provided. In one embodiment, the front rail includes a set of spaced fasteners integral with a body of the front rail. The fasteners cooperate with apertures provided in an associated subjacent shelf to which the front rail is selectively secured. The fasteners can be resilient so as to allow the front rail to be readily secured to or removed from the associated subjacent shelf.

In one embodiment, a merchandising system includes a front rail and at least one fastener element of one piece with the front rail and adapted to selectively connect the front rail to an associated subjacent shelf. The fastener element can comprise a snap protrusion. The fastener element can include a first portion, a second portion and a gap defined between the first portion and the second portion. At least one of the first and second portions can include a distal portion comprising a tapered side wall, a central portion and a proximal portion. The proximal portion can include a tapered side wall. The tapered side wall of the distal portion tapers towards an end face of the at least one of the first and second portions. The tapered side wall of the proximal portion tapers towards a bottom surface of the front rail.

In another embodiment, the fastener element can comprise a generally cylindrical member which includes a hollow central area. In a further embodiment, the fastener element can comprise at least one groove or channel which is defined in an outer surface of the fastener element. The groove or channel can extend generally along a longitudinal axis of the fastener element.

The front rail can include a top surface and a bottom surface and the at least one fastener element can protrude from the bottom surface. A plurality of spaced fastener elements can protrude from the bottom surface. The plurality of spaced fastener elements can be selectively inserted into apertures defined in the associated subjacent shelf. The system can further comprise a divider selectively connected to the front rail. Further, the system can comprise a pusher assembly selectively connected to the front rail.

### BRIEF DESCRIPTION OF THE DRAWINGS

The present disclosure may take physical form in certain parts and arrangements of parts, several embodiments of which will be described in detail in the specification and illustrated in the accompanying drawings which form a part hereof and wherein;

FIG. 1 is an exploded perspective view of a prior art adjustable merchandising system;

FIG. 2 is an exploded perspective view of one embodiment of a front rail according to the present disclosure;

FIG. 3 is a perspective bottom view of another embodiment of a front rail according to the present disclosure;

FIG. 4 is an enlarged view of a portion of the front rail of FIG. 3;

FIG. 5 is a top plan view of a front rail according to still another embodiment of the present disclosure;

FIG. 6 is an enlarged front elevational view of the front rail of FIG. 5;

FIG. 7 is an enlarged view of a portion of the front rail of FIG. 6;

FIG. 8 is a side elevational view of a front rail according to yet another embodiment of the present disclosure; and,

FIG. 9 is an enlarged bottom plan view of a portion of the front rail of FIG. 8.

### DETAILED DESCRIPTION

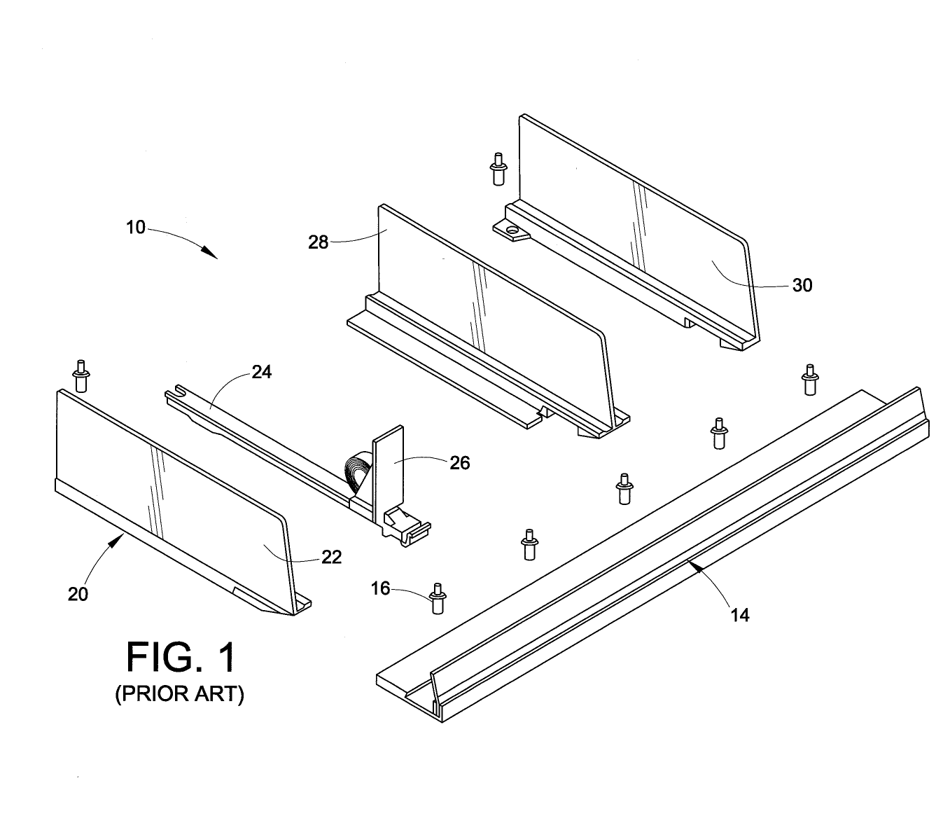

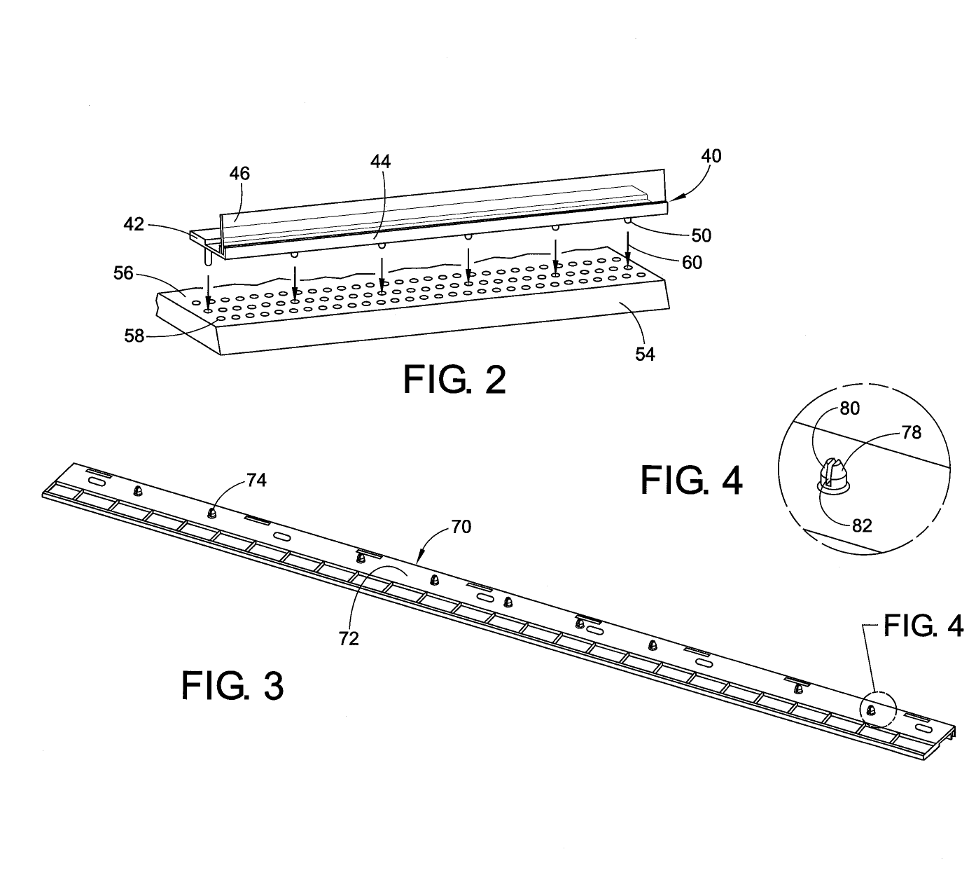

Referring now to the drawings wherein the showings are for purposes of illustrating several embodiments of the present disclosure and not for purposes of limiting same, FIG. 1 shows a prior art merchandising system. This includes a front rail 14 which is selectively secured to a subjacent shelf (see FIG. 2) via a set of separate fasteners 16. It is noted that the fasteners are separate elements and need to be manually installed in suitable apertures (not illustrated) in the front rail in order to secure the front rail to a subjacent shelf. When a barrier or transparent lens is connected to the front rail (by being positioned in a longitudinally extending groove defined in the front rail) it is sometimes called a front fence. Mounted to the front rail is a product feed system 20. In the embodiment illustrated, the product feed system includes a left end wall 22, a track 24 on which is mounted a pusher 26, for urging a column of product forward towards the front end of a shelf, and a divider 28. It should be appreciated that any number of tracks and dividers can be employed, depending upon the number of columns of merchandise which are meant to be vended on a particular shelf. Moreover, it is also known to have an integrated pusher and divider assembly and such a structure can also be selectively secured to the front rail 14. A right end wall 30 is mounted opposite the left end wall 22, thus defining the product feed system 20 on the shelf.

One disadvantage of the front rail 14 illustrated in FIG. 1 is that separate fasteners 16 need to be employed in order to selectively connect the front rail to a subjacent shelf. Thus, packaged together with the front rail, or at least accessible to the person at the store installing the front rail, needs to be a set of fasteners 16 so that the front rail can be connected to a shelf. As might be appreciated, the fasteners are small and are easily lost during the installation process, thus leading to wastage. More importantly, the amount of labor involved in installing the fasteners to connect the front rail to a shelf is not insignificant. Therefore, the installation process can be costly, both from a man power and a parts standpoint.

According to the present disclosure, an improved front rail is provided in which the fasteners that secure the front rail to the subjacent shelf are of one piece with or integral with the body of the front rail. One such embodiment is illustrated in FIG. 2. In this embodiment, the front rail is generally L-shaped and includes a horizontal section 42 and a vertical section 44. Selectively mounted in the vertical section is a front fence 46 which is generally made of a transparent material so that the product being sold on the shelf is clearly visible. Extending from a bottom face of the front rail 40 is a set of fasteners 50, which are integral with the front rail. The fasteners 50 are so spaced and sized as to allow the front rail to be connectable to a subjacent shelf. In one embodiment, a shelf 54 includes a top surface 56 in which are defined a plurality of spaced apertures 58. The fasteners 50 are capable of being inserted into the apertures 58 as is illustrated by arrows 60.

With reference now to FIG. 3, another embodiment of a front rail 70 is there illustrated. In this embodiment, the front rail includes a bottom wall 72 on which are located a plurality of spaced fasteners 74. With reference now to FIG. 4, in one embodiment, the fasteners 74 can comprise a first section 78 and a second section 80 with the two sections being separated from one another by a slot 82. It should be appreciated that the fasteners 74 protrude away from the bottom wall 72 in a direction approximately normal to a plane of the bottom wall 72.

Generally speaking, the front rail is made of a suitable conventional thermoplastic material and so, too, are the fasteners 74 which, as mentioned, are of one piece with the material of the front rail. Due to the inherent resiliency of such thermoplastic material, and the presence of the slot 82, the fastener can flex radially so as to be capable of entering an aperture in the shelf and then flexing outwardly so as to snap into place and lock the front rail to the shelf in a resilient manner. In one embodiment, the front rail is molded of a conventional thermoplastic material such that the fasteners 74 are molded together with the front rail 70, thus forming a one-piece unitary product. Due to the inherent resiliency of the fasteners 74, the front rail 70 can also be removed from the shelf as may be required in certain circumstances.

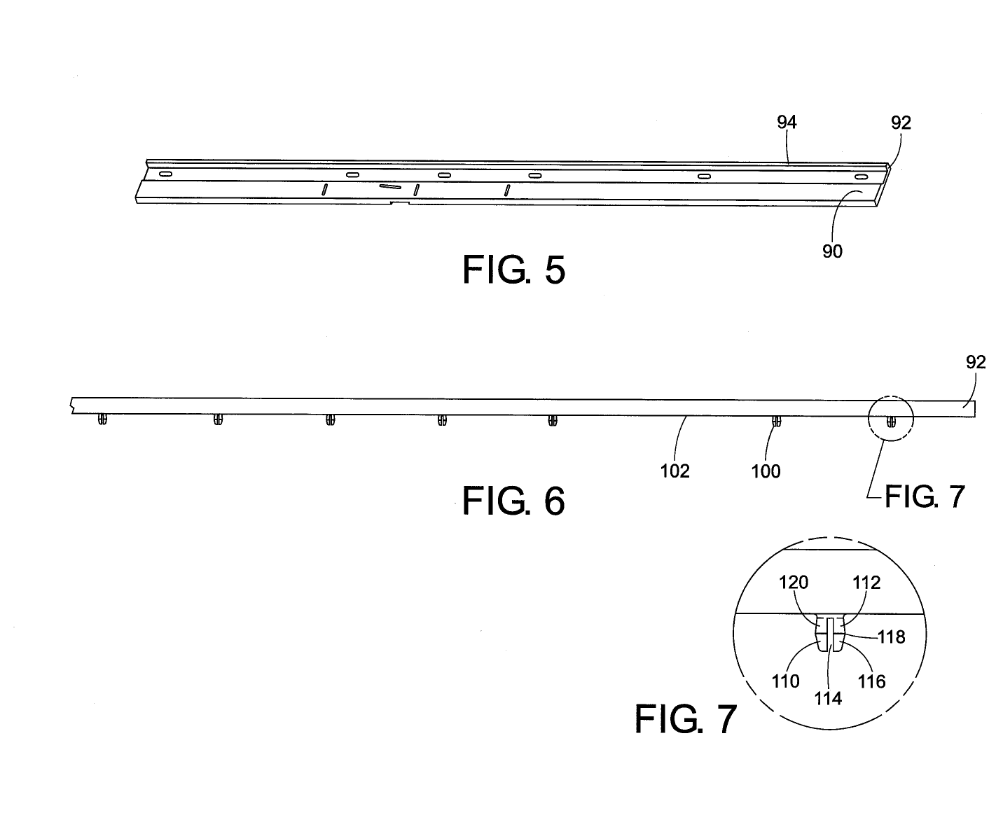

With reference now to FIG. 5, a top perspective view of another front rail is there illustrated. The front rail includes a horizontal section 90 and a vertical section 92 in which is defined a longitudinally extending slot 94. As may be recognized, the slot 94 is employed to hold a front fence. FIG. 6 is an enlarged front plan view of the front rail of FIG. 5. It illustrates integral fasteners 100 which extend from a bottom face 102 of the front rail. With reference now to FIG. 7, the fasteners can each include a first section 110 which is separated from the second section 112 by a slot 114. It should be appreciated from FIG. 7 that the fasteners are tapered so as to have a tapered distal end 116 leading to an enlarged central portion 118 and a somewhat tapered or reduced diameter proximal end 120. Thus, each of the two fastener sections 110 and 112 have a tapered distal section, an enlarged central portion and a somewhat reduced diameter proximal section. This configuration of the fastener allows the fastener to readily enter the apertures in the shelf, snap into place, and be generally securely positioned in the aperture so as to retard the removal of the front rail from the shelf holding it. However, due to the inherent resiliency of the thermoplastic material from which the fastener is made, the front rail can be peeled away from its support shelf by pulling upwardly on one end of the front rail and thereby serially disengaging each of the fasteners 100 from the apertures in the shelf on which the front rail was mounted.

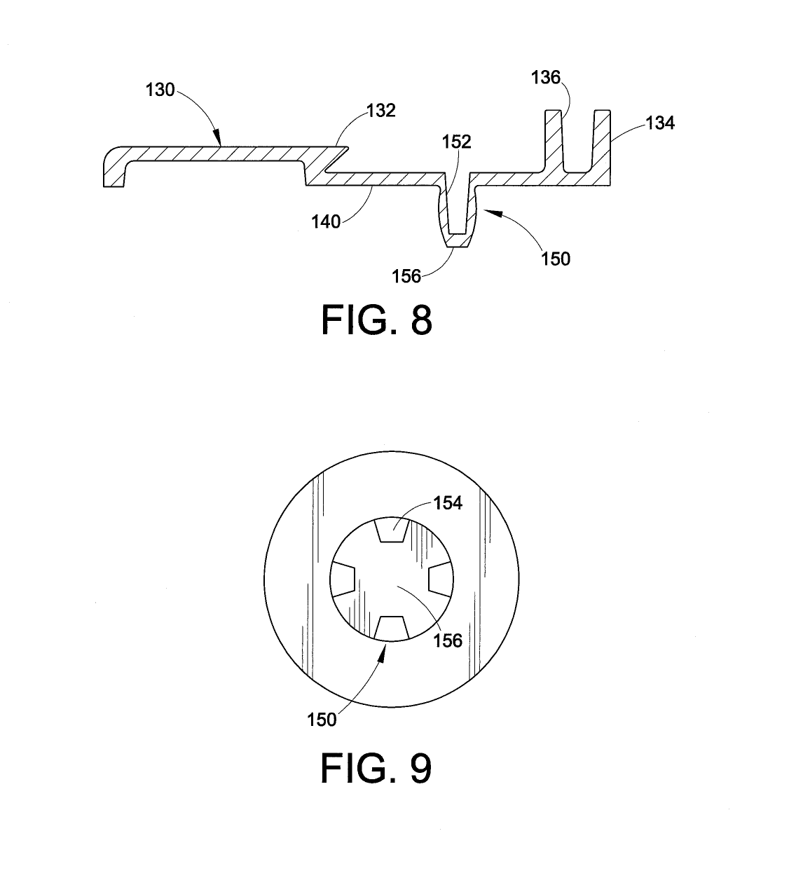

With reference now to FIG. 8, a side elevational cross-sectional view of another front rail according to the present disclosure is there illustrated. The front rail 130 includes a horizontal section 132 and a vertical section 134 in which is defined a longitudinally extending slot 136. Depending from a bottom face 140 of the front rail 130 is a fastener 150. It can be seen that the fastener includes a hollow central section 152. This enhances the resiliency of the fastener 150 as the front rail 130 is made from a suitable thermoplastic or like resilient material. With reference now to FIG. 9, an outer surface of the fastener 150 can include one or more indented portions, grooves or channels 154. These serve to further increase the resiliency of the fastener and enable it to snap more easily into corresponding apertures in the shelf to which the front rail is selectively secured via the fasteners. In the embodiment illustrated in FIG. 9, four such slots or grooves 154 are defined. It can be appreciated that each of these extends generally vertically from a bottom face 156 of the fastener upwardly towards the bottom surface 140 of the front rail.

It should be appreciated that there are several different shelving manufacturers producing shelving for grocery stores, drug stores, hardware stores and the like. The different manufacturers produce shelving where the spacing between adjacent apertures in the shelving varies from one manufacturer to another. Therefore, it is contemplated that a plurality of front rails would be provided with snap protrusions located in specific positions to accommodate the aperture spacing of each of the several shelf manufacturers.

One advantage of the present disclosure is a new and improved shelf management system, including a front rail which can be readily mounted to and detached from a support shelf without the use of separately providing fasteners. Another advantage of the present disclosure is that it dispenses with the need for using separate fasteners which are physically disconnected from the front rail and are, thus, easily lost and more time consuming (and expensive) to install or remove.

The disclosure has been described with reference to several embodiments. Obviously, modification and alterations will occur to others upon a reading and understanding of this specification. It is intended to include all such modifications and alterations insofar as they come within the scope of the appended claims and the equivalents thereof.

What is claimed is:

1. A merchandising system comprising a front rail and at least one fastener element of one piece with the front rail and adapted to selectively connect the front rail to an associated subjacent shelf.

2. The system of claim 1 wherein the fastener element comprises a snap protrusion.

3. The system of claim 1 wherein the fastener element comprises:
a first portion;
a second portion; and
a gap defined between said first and second portions.

4. The system of claim 3 wherein at least one of the first and second portions includes:
a distal portion comprising a tapered side wall;
a central portion; and
a proximal portion.

5. The system of claim 4 wherein the proximal portion includes a tapered side wall.

6. The system of claim 5 wherein the tapered side wall of the distal portion tapers towards an end face of the at least one of the first and second portions.

7. The system of claim 6 wherein the tapered side wall of the proximal portion tapers towards a bottom surface of the front rail.

8. The system of claim 1 wherein the fastener element comprises a generally cylindrical member including a hollow central area.

9. The system of claim 1 wherein the fastener element comprises at least one groove or channel defined in an outer surface of the fastener element.

10. The system of claim 9 wherein the groove or channel extends generally along a longitudinal axis of the fastener element.

11. The system of claim 1 wherein the front rail includes a top surface and a bottom surface and wherein the at least one fastener element protrudes from the bottom surface.

12. The system of claim 11 wherein a plurality of fastener elements spaced along a longitudinal axis of the front rail protrude from the bottom surface of the front rail.

13. The system of claim 12 wherein the plurality of spaced fastener elements can be selectively inserted into apertures defined in the associated subjacent shelf.

14. The system of claim 1 further comprising a divider selectively connected to the front rail.

15. The system of claim 14 further comprising a pusher assembly selectively connected to the front rail.
